(19) United States
(12) Patent Application Publication
(10) Pub. No.: US 2022/0092260 A1
(43) Pub. Date: Mar. 24, 2022

(54) INFORMATION OUTPUT APPARATUS, QUESTION GENERATION APPARATUS, AND NON-TRANSITORY COMPUTER READABLE MEDIUM

(71) Applicant: FUJIFILM BUSINESS INNOVATION CORP., Tokyo (JP)

(72) Inventor: Seiya INAGI, Kanagawa (JP)

(73) Assignee: FUJIFILM BUSINESS INNOVATION CORP., Tokyo (JP)

(21) Appl. No.: 17/165,349

(22) Filed: Feb. 2, 2021

(30) Foreign Application Priority Data
Sep. 18, 2020 (JP) 2020-157394

(51) Int. Cl. G06F 40/242; G06F 40/30; G06K 9/62; G06F 16/332

(52) U.S. Cl. CPC G06F 40/242; G06F 16/3329; G06K 9/6259; G06F 40/30

(57) ABSTRACT

An information output apparatus includes: a processor configured to: calculate a difference between (i) a semantic representation of a specific user known word obtained from a first model that has learned semantic representations of words using a specific set of example sentences and (ii) a semantic representation of the specific user known word obtained from a second model that has learned semantic representations of words using a part of the specific set of example sentences excluding a target word; and output information on a possibility that the target word is a user known word based on the difference.

### CROSS-REFERENCE TO RELATED APPLICATIONS

This application is based on and claims priority under 35 USC 119 from Japanese Patent Application No. 2020-157394 filed Sep. 18, 2020.

### BACKGROUND

### (i) Technical Field

The present disclosure relates to an information output apparatus, a question generation apparatus, and a non-transitory computer readable medium.

### (ii) Related Art

Techniques have been known that generates pairs of two language patterns in which one pattern implies another pattern (for example, see Japanese Patent No. 6551968).

### SUMMARY

For example, a user may be asked a question using a word, and a process may be performed using an answer of the user to the question. At this time, when the user does not know a meaning of the word, a quality or amount of the answer decreases. Thus it is desirable that the word is a word whose meaning is known to the user (hereinafter, referred to as a “user known word”). Here, in order to find the user known words, it is conceivable to perform a questionnaire or the like, but the questionnaire is not an efficient method from the viewpoint of time, cost, and the like.

Aspects of non-limiting embodiments of the present disclosure relate to making it possible to efficiently find user known words as compared with a case where the user known words are found through a questionnaire or the like.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information output apparatus including: a processor configured to: calculate a difference between (i) a semantic representation of a specific user known word obtained from a first model that has learned semantic representations of words using a specific set of example sentences and (ii) a semantic representation of the specific user known word obtained from a second model that has learned semantic representations of words using a part of the specific set of example sentences excluding a target word; and output information on a possibility that the target word is a user known word based on the difference.

### BRIEF DESCRIPTION OF THE DRAWINGS

Exemplary embodiment(s) of the present disclosure will be described in detail based on the following figures, wherein:

FIG. 1 is a diagram showing a hardware configuration example of a question generation apparatus according to an exemplary embodiment of the present disclosure;

FIG. 2 is a block diagram showing a functional configuration example of the question generation apparatus according to the exemplary embodiment of the present disclosure;

FIGS. 3A and 3B are diagrams showing specific examples of a corpus stored in the question generation apparatus according to the exemplary embodiment of the present disclosure;

FIGS. 4A and 4B are diagrams showing specific examples of a learned model stored in the question generation apparatus according to the exemplary embodiment of the present disclosure;

FIGS. 5A and 5B are diagrams showing specific examples of output information stored in the question generation apparatus according to the exemplary embodiment of the present disclosure;

FIG. 6 is a diagram showing a specific example of output difference information stored in the question generation apparatus according to the exemplary embodiment of the present disclosure; and

FIG. 7 is a flowchart showing an operation example of the question generation apparatus according to the exemplary embodiment of the present disclosure.

### DETAILED DESCRIPTION

Hereinafter, an exemplary embodiment of the present disclosure will be described in detail with reference to the accompanying drawings.

### Overview of Present Exemplary Embodiment

The present exemplary embodiment is an information output apparatus calculate a difference between (i) a semantic representation of a specific user known word obtained from a first model that has learned semantic representations of words using a specific set of example sentences and (ii) a semantic representation of the specific user known word obtained from a second model that has learned semantic representations of words using a part of the specific set of example sentences excluding a target word, and output information on a possibility that the target word is a user known word based on the difference.

Here, the information output apparatus may calculate the difference for one target word, and if the difference is equal to or greater than a threshold value, output information indicating that the target word is determined to be a user known word as the information on the possibility that the target word is the user known word.

Alternatively, the information output apparatus may calculate plural differences by calculating the difference for each of plural target words, and output the plural target words arranged in order based on the differences for the respective target words, as information on the possibilities that the target words are the user known words.

The information output apparatus may be any of these, and the latter case will be described below. It is assumed that a question obtained by using the plural target words is generated instead of simply outputting the plural target words.

In this case, the present exemplary embodiment is an question generation apparatus calculate plural differences by calculating, for each of plural target words, a difference between (i) a semantic representation of a specific user known word obtained from a first model that has learned semantic representations of words using a specific set of example sentences and (ii) a semantic representation of the specific user known word obtained from a second model that has learned semantic representations of words using a part of the specific set of example sentences excluding the target word, and generate a question using the plural target words based on the plural differences.

Therefore, in the following, a case in which the present exemplary embodiment is the question generation apparatus will be described as an example.

Here, the question generation apparatus is an apparatus that generates a question to be given to the user. The apparatus may be, for example, an apparatus that generates a question in a system that solves a target task using an answer of a user to the question. Examples of the task include word classification and word-to-word relevance prediction.

The following methods may be considered as a method for the system to ask a question.

When the target task is a word classification task, the system presents a word and classification items, and asks the user a classification item that is most likely to be related to the word.

When the target task is a word-to-word relevance prediction task, the system presents two words and asks the user about how related the two words are.

The term “a set of example sentences” is a collection of some example sentences. The example sentence may be a relatively long sentence such as an article or a book, which may be generally referred to as a “document”, or may be a relatively short sentence such as a sentence of a conversation. The example sentence may include not only a sentence recorded as text data, but also a sentence recorded as audio data, for example. Further, the example sentences are not limited to ones collected for the purpose of a research of natural language processing, but may be ones collected for any purpose. Hereinafter, a corpus will be described as an example of the set of example sentences.

Further, the phrase “part of the specific set of example sentences excluding the target word” refers to a part obtained by performing some process on the specific set of example sentences such that the part does not include the target word. This process may be, for example, a process of masking the target word or a process of temporarily deleting the target word. The former process will be described below as an example.

Further, the term “semantic representation of a word” refers to one obtained by vectorizing a meaning of the word so as to represent the meaning of the word. It is noted that, since the present exemplary embodiment may simply need to calculate how close meanings of words are using the semantic representations of the words, the semantic representation of the word may be one represented by another method that enables at least calculating how close meanings of words are.

Further, the phrase “order based on the differences” refers to order that is determined using the differences. The “order based on the differences” may be descending order of the difference, or order that is not only basically based on the descending order of the difference but also based on other elements. Here, the other elements may be differences when plural other user known words are used. For example, if a difference is small when only a specific user known word is used, but an average of differences when other plural user known words are used is large or a variance of the differences when the other plural user known words are used is small, the ranking of a target word may be raised. Alternatively, the other elements may be a grammatical attribute of the target word or the like. In the following, a case where the descending order of the difference is used as order based on the differences will be described as an example.

### Hardware Configuration of Question Generation Apparatus

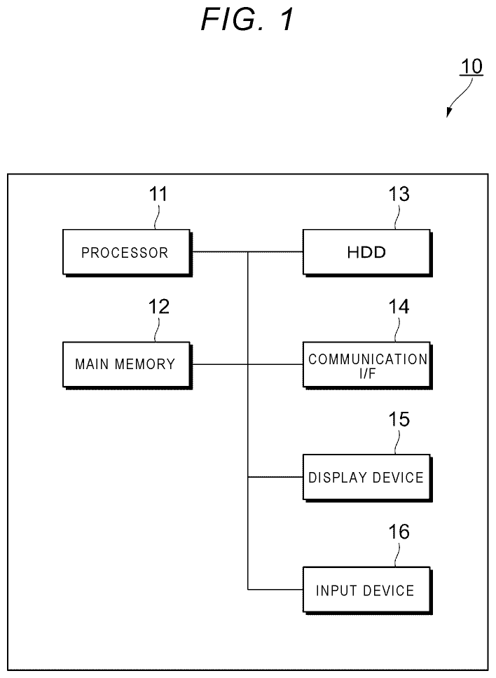

FIG. 1 is a diagram showing a hardware configuration example of a question generation apparatus 10 according to the present exemplary embodiment. As shown in FIG. 1, the question generation apparatus 10 includes a processor 11 that is an operating unit, and a main memory 12 and a Hard Disk Drive (HDD) 13 that are storages. Here, the processor 11 executes various software, such as an operating system (OS) and an application, and implements each function to be described later. The main memory 12 is a storage area that stores various software and data used in executing the software. The HDD 13 is a storage area that stores input data for the various software, output data from the various software, and the like. The question generation apparatus 10 further includes a communication I/F (hereinafter, referred to as “I/F”) 14 that communicates with an outside, a display device 15 such as a display, and an input device 16 such as a keyboard and a mouse.

### Functional Configuration of Question Generation Apparatus

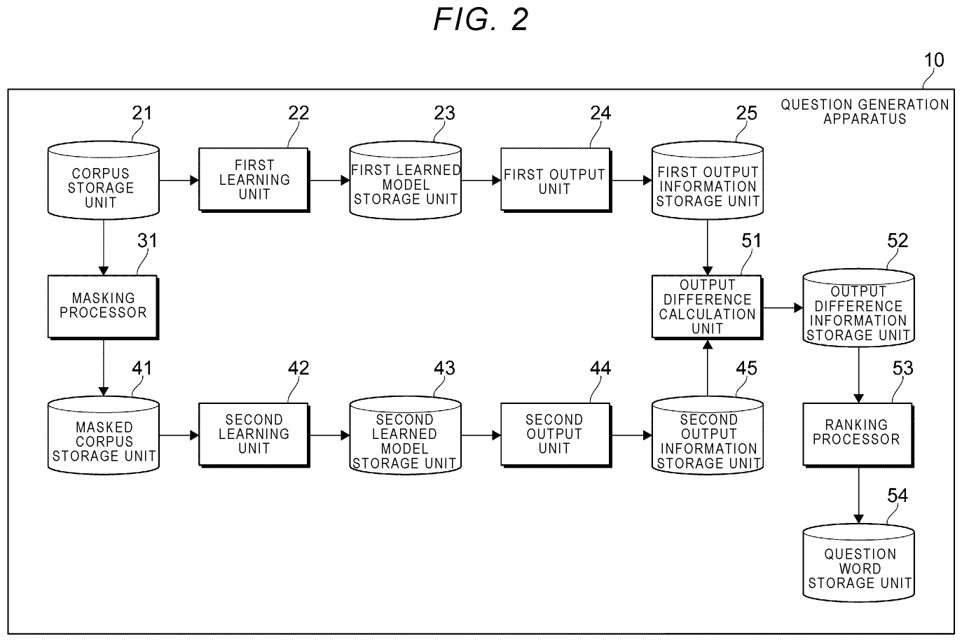

FIG. 2 is a block diagram showing a functional configuration example of the question generation apparatus 10 according to the present exemplary embodiment. As shown in FIG. 2, the question generation apparatus 10 includes a corpus storage unit 21, a first learning unit 22, a first learned model storage unit 23, a first output unit 24, and a first output information storage unit 25. The question generation apparatus 10 includes a masking processor 31. The question generation apparatus 10 further includes a masked corpus storage unit 41, a second learning unit 42, a second learned model storage unit 43, a second output unit 44, and a second output information storage unit 45. The question generation apparatus 10 further includes an output difference calculation unit 51, an output difference information storage unit 52, a ranking processor 53, and a question word storage unit 54.

The corpus storage unit 21 stores a corpus. The corpus is, for example, a specific corpus in a field in which a question is asked. A specific example of the corpus stored in the corpus storage unit 21 will be described later.

The first learning unit 22 generates a first learned model by causing a model to learn semantic representations of words using the corpus stored in the corpus storage unit 21. In the present exemplary embodiment, the first learned model is used as an example of a first model that has learned semantic representations of words using a specific set of example sentences. Here, the first learning unit 22 may generate the first learned model by causing a model that has not learned at all to learn using the corpus stored in the corpus storage unit 21. Alternatively, the first learning unit 22 may generate the first learned model by updating a model that has already learned, using the corpus stored in the corpus storage unit 21.

The first learned model storage unit 23 stores the first learned model generated by the first learning unit 22. A specific example of the first learned model stored in the first learned model storage unit 23 will be described later.

The first output unit 24 outputs a semantic representation of a specific user known word obtained from the first learned model stored in the first learned model storage unit 23 as first output information. In the present exemplary embodiment, the first output information is used as an example of the semantic representation of the specific user known word obtained from the first model.

The first output information storage unit 25 stores the first output information output by the first output unit 24. A specific example of the first output information stored in the first output information storage unit 25 will be described later.

The masking processor 31 performs a masking process on the corpus stored in the corpus storage unit 21 to mask a target word (hereinafter, referred to as “examination target word”) whose contribution to the specific user known word is to be examined, to generate a masked corpus. In the present exemplary embodiment, the examination target word is used as an example of the target word, and the masked corpus is used as an example of the part of the specific set of example sentences excluding the target word.

The masked corpus storage unit 41 stores the masked corpus generated by the masking processor 31. A specific example of the masked corpus stored in the masked corpus storage unit 41 will be described later.

The second learning unit 42 generates a second learned model by causing a model to learn semantic representations of words using the masked corpus stored in the masked corpus storage unit 41. In the present exemplary embodiment, the second learned model is used as an example of a second model that has learned semantic representations of words using a part of the specific set of example sentences excluding a target word. Here, the second learning unit 42 may generate the second learned model by causing a model that has not learned at all to learn using the masked corpus stored in the masked corpus storage unit 41. In this case, the second learned model is an example of a model obtained by causing an unlearned model to newly learn semantic representations of words using the part of the specific set of example sentences excluding the target word. Alternatively, the second learning unit 42 may generate the second learned model by updating a model that has already learned, using the masked corpus stored in the masked corpus storage unit 41. In this case, the second learned model is an example of a model obtained by causing a learned model to further learn semantic representations of words using the part of the specific set of example sentences excluding the target word.

The second learned model storage unit 43 stores the second learned model obtained by the second learning unit 42. A specific example of the second learned model stored in the second learned model storage unit 43 will be described later.

The second output unit 44 outputs the semantic representation of the specific user known word obtained from the second learned model stored in the second learned model storage unit 43 as second output information. In the present exemplary embodiment, the second output information is used as an example of the semantic representation of the specific user known word obtained from the second model.

The second output information storage unit 45 stores the second output information output by the second output unit 44. A specific example of the second output information stored in the second output information storage unit 45 will be described later.

The output difference calculation unit 51 calculates, for each of plural examination target words, an output difference that is a difference between the first output information stored in the first output information storage unit 25 and the second output information stored in the second output information storage unit 45 when the examination target word is selected. In the present exemplary embodiment, the output difference calculation unit 51 is provided as an example of a unit configured to calculate a difference between the semantic representation of the specific user known word obtained from the first model and the semantic representation of the specific user known word obtained from the second model. In the present exemplary embodiment, the output difference calculation unit 51 is also provided as an example of a unit configured to calculate plural differences by calculating, for each of plural target words, the difference between (i) the semantic representation of the specific user known word obtained from the first model and (ii) the second representation of the specific user known word obtained from the second model.

The output difference information storage unit 52 stores, for each of the plural examination target words, the output difference information in which the examination target word is associated with the output difference calculated by the output difference calculation unit 51 when the examination target word is selected.

The ranking processor 53 arranges and outputs the plural examination target words in descending order of the output difference stored in the output difference information storage unit 52, that is, in descending order of a possibility that the examination target word is the user known word, as words (hereafter referred to as “question words”) used in the question given to the user. This is based on an idea that it is considered that, if the semantic representation of the specific user known word when the corpus includes the examination target is significantly different from that when the corpus does not include the examination target word, the semantic representation of the specific user known word is not obtained without the examination target word, and thus the examination target word can be determined to be the user known word. In the present exemplary embodiment, the ranking processor 53 is provided as an example of a unit configured to output information on a possibility that the target word is a user known word based on the difference. In the present exemplary embodiment, the ranking processor 53 is also provided as an example of a unit configured to generate a question using the plural target words based on the plural differences.

The question word storage unit 54 stores the question words output by the ranking processor 53 in order in which the question words are arranged by the ranking processor 53. Then, the system that executes the task extracts the question words stored in the question word storage unit 54 in order in which the question words are stored in the question word storage unit 54, and uses the question words in the question given to the user.

These functional units are implemented by cooperation of software and hardware resources. Specifically, these functional units are implemented by the processor 11 reading a program implementing these functions from, for example, the HDD 13 into the main memory 12 and executing the program.

Next, a specific example of the corpus stored in the question generation apparatus 10 according to the present exemplary embodiment will be described.

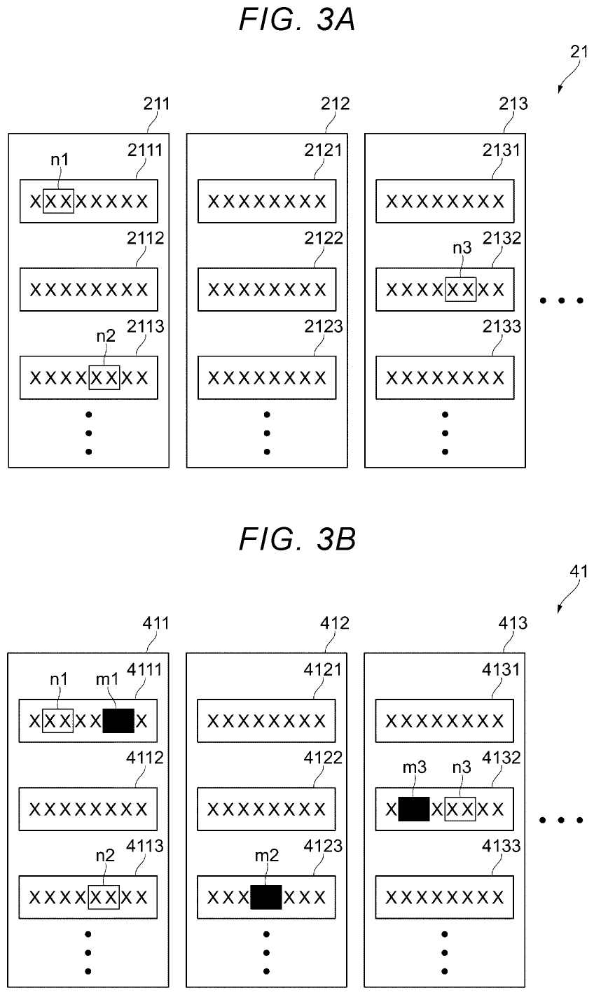

FIG. 3A is a diagram showing a specific example of the corpus stored in the corpus storage unit 21. As shown in FIG. 3A, the corpus stored in the corpus storage unit 21 includes documents 211, 212, 213, . . . . The document 211 includes sentences 2111, 2112, 2113, . . . , the document 212 includes sentences 2121, 2122, 2123, . . . , and the document 213 includes sentences 2131, 2132, 2133, . . . . Here, it is assumed that user known words n1, n2, and n3 are present in the sentences 2111, 2113, and 2132, respectively.

FIG. 3B is a diagram showing a specific example of the masked corpus stored in the masked corpus storage unit 41. As shown in FIG. 3B, the masked corpus stored in the masked corpus storage unit 41 is obtained by masking the examination target word in the corpus stored in the corpus storage unit 21. Here, it is assumed that the examination target words m1, m2, and m3 are present in sentences 4111, 4123, and 4132, respectively, and are masked.

In FIGS. 3A and 3B, data are stored in the masked corpus storage unit 41 in units of sentences. The present disclosure is not limited to this example. The unit of data may be more generalized and may be any of elements of a document. The elements of the document include a paragraph, a chapter, and a section in addition to the sentence.

In FIG. 3B, a sentence including only a user known word and a sentence including neither a user known word nor an examination target word are also stored in the masked corpus storage unit 41. It is noted that the present disclosure is not limited these examples. The sentence including only the user known word and the sentence including neither the user known word nor the examination target word may not be stored in the masked corpus storage unit 41.

Specifically, when the second learning unit 42 causes the model that has not learned at all to learn, the second learning unit 42 may perform filtering so as to allow only sentences each including either a user known word or an examination target word to pass through and store the sentences in the masked corpus storage unit 41. That is, in the example in FIG. 3B, the sentences 4111, 4113, 4123, and 4132 may be stored in the masked corpus storage unit 41. This is an example of a case where the part of the specific set of example sentences excluding the target word is a part of an element, which includes at least one of the specific user known word or the target word, of the specific set of example sentences excluding the target word.

On the other hand, when the second learning unit 42 updates the already learned model, the second learning unit 42 may perform filtering so as to allow only sentences each including an examination target word to pass through and store the sentences in the masked corpus storage unit 41. That is, in the example in FIG. 3B, the sentences 4111, 4123, and 4132 may be stored in the masked corpus storage unit 41. This is because it can be assumed that the user known words are included in the learned model before the update. This is an example of a case where the part of the specific set of example sentences excluding the target word is a part of an element, which includes the target word, of the specific set of example sentences excluding the target word.

Next, a specific example of the learned model stored in the question generation apparatus 10 according to the present exemplary embodiment will be described. Hereinafter, a case where the semantic representations of the words are learned by a continuous bag-of-words (CBOW) model among two types of models constituting Word 2Vec will be described as an example.

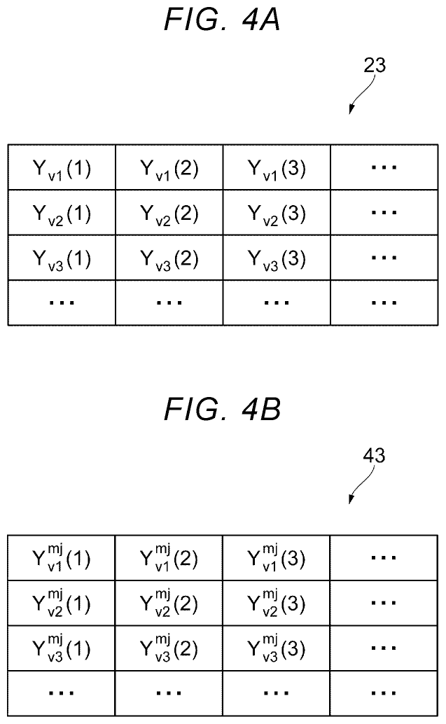

FIG. 4A is a diagram showing a specific example of the first learned model stored in the first learned model storage unit 23. Here, a first learned model that is an output of the CBOW model with a corpus X as an input is denoted by Y. The first learned model Y is a matrix of V×W having a semantic representation of a word in each row. V is the number of words, and W is the number of dimensions of the semantic representation. Hereinafter, a semantic representation in a row of a word v and a dimension w in the first learned model Y is denoted by Yᵥ(w). In FIG. 4A, a first row of the first learned model Y represents semantic representations of a word v1 in dimensions 1, 2, 3, . . . . A second row represents semantic representations of a word v2 in the dimensions 1, 2, 3, . . . . A third row represents semantic representations of a word v3 in the dimensions 1, 2, 3, . . . .

FIG. 4B is a diagram showing a specific example of the second learned model stored in the second learned model storage unit 43. Here, a corpus X obtained by the masking processor 31 masking an examination target word mj is referred to as a “corpus X^{mj}”, and a second learned model that is the output of the CBOW model with the corpus X^{mj} as an input, is denoted by Y^{mj}. The second learned model Y^{mj} is also a matrix of V×W having a semantic representation of a word in each row. Hereinafter, a semantic representation in a row of a word v and a dimension w in the second learned model Y^{mj} is denoted by Yᵥ^{mj}(w). In FIG. 4B, a first row of the second learned model Y^{mj} represents semantic representations of the word v1 in the dimensions 1, 2, 3, . . . . A second row represents semantic representations of the word v2 in the dimensions 1, 2, 3 . . . . A third row represents semantic representations of the word v3 in the dimensions 1, 2, 3, . . . .

Next, a specific example of the output information stored in the question generation apparatus 10 according to the present exemplary embodiment will be described.

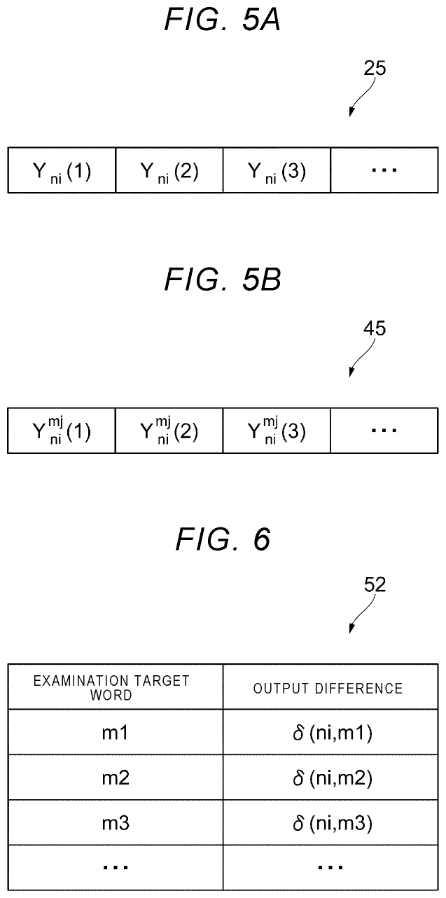

FIG. 5A is a diagram showing a specific example of the first output information stored in the first output information storage unit 25. As shown in FIG. 5A, the first output information is obtained by extracting a row corresponding to a user known word ni from the first learned model Y. Here, the first output information, which is the extracted row, is denoted by Yₙᵢ. The first output information Yₙᵢ is a W-dimensional vector having semantic representations of the word as elements.

FIG. 5B is a diagram showing a specific example of the second output information stored in the second output information storage unit 45. As shown in FIG. 5B, the second output information is obtained by extracting a row corresponding to the user known word ni from the second learned model Y^{mj}. Here, the second output information, which is the extracted row, is denoted by Yₙᵢ^{mj}. The second output information Yₙᵢ^{mj} is a W-dimensional vector having semantic representations of the word as elements.

Next, a specific example of the output difference information stored in the question generation apparatus 10 according to the present exemplary embodiment will be described.

FIG. 6 is a diagram showing a specific example of the output difference information stored in the output difference information storage unit 52. As shown in FIG. 6, in the output difference information, the examination target word is associated with the output difference. The examination target word is mj, and the output difference is δ(ni, mj) (j=1, 2, 3, . . . ). Here, the output difference δ(ni, mj) is defined as a squared distance between the first output information Yₙᵢ and the second output information Y^{mj}ₙᵢ when the examination target word mj is masked.

Thereafter, the ranking processor 53 sorts the examination target words mj in descending order of the output difference δ(ni, mj) and stores the examination target words mj in the question word storage unit 54.

### Operation of Question Generation Apparatus

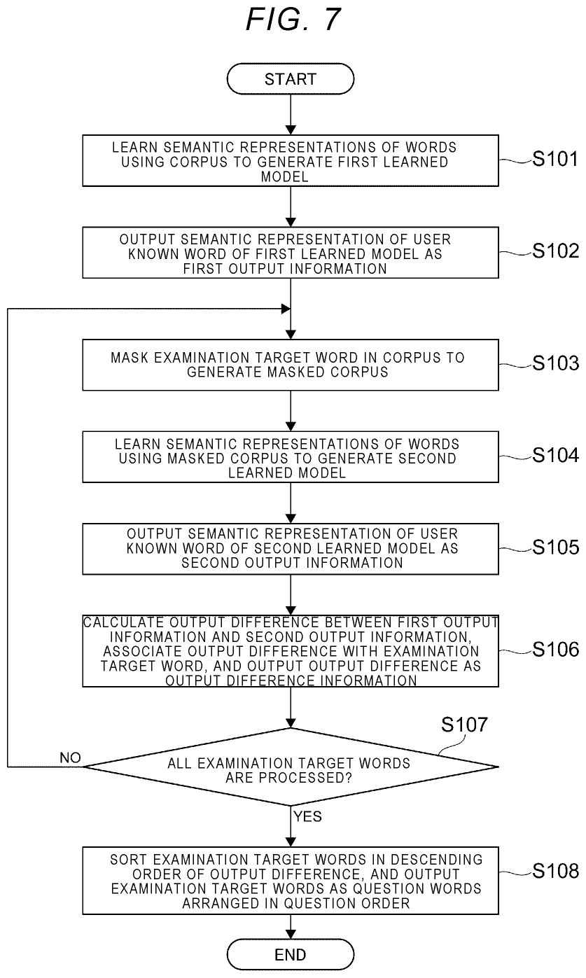

FIG. 7 is a flowchart showing an operation example of the question generation apparatus 10 according to the present exemplary embodiment.

As shown FIG. 7, in the question generation apparatus 10, first, the first learning unit 22 uses the corpus stored in the corpus storage unit 21 to learn semantic representations of words to generate a first learned model (step 101). The first learned model is stored in the first learned model storage unit 23.

Next, the first output unit 24 extracts semantic representations of user known words from the first learned model stored in the first learned model storage unit 23 and outputs the semantic representations as the first output information (step 102). The first output information is stored in the first output information storage unit 25.

Meanwhile, in the question generation apparatus 10, the masking processor 31 performs the masking process of masking an examination target word, on the corpus stored in the corpus storage unit 21 to generate a masked corpus (step 103). The masked corpus is stored in the masked corpus storage unit 41.

Next, the second learning unit 42 uses the corpus stored in the masked corpus storage unit 41 to learn semantic representations of words to generate a second learned model (step 104). The second learned model is stored in the second learned model storage unit 43.

Next, the second learning unit 42 extracts a semantic representation of the user known word from the second learned model stored in the second learned model storage unit 43 and outputs the semantic representations as second output information (step 105). The second output information is stored in the second output information storage unit 45.

Next, the question generation apparatus 10 calculates an output difference between the first output information stored in the first output information storage unit 25 and the second output information stored in the second output information storage unit 45, associates the output difference with the examination target word, and outputs the examination target word and the output difference as the output difference information (step 106). The output difference information is stored in the output difference information storage unit 52.

Thereafter, the question generation apparatus 10 determines whether all the examination target words are processed (step 107). That is, the question generation apparatus 10 determines whether there remains no examination target word to which attention is to be paid.

As a result, if determining that all the examination target word are not processed, the question generation apparatus 10 returns the process to step 103. Then, attention is paid to another examination target word, and the process of steps 103 to 106 is performed.

On the other hand, if determining that all the examination target word are processed, the question generation apparatus 10 causes the process to proceed to step 108.

Then, the ranking processor 53 sorts the examination target words in descending order of the output difference and outputs the examination target words as question words arranged in question order (step 108). The question words are stored in the question word storage unit 54.

### Modification

Although not mentioned in the above exemplary embodiment, the system may specify a new user known word at a time point when an answer to a question is obtained from the user, and reflect the new user known word in the corpus stored in the corpus storage unit 21. Here, the new user known word may be specified by the user explicitly notifying the system whether he/she knows a meaning of the word in a task. Thus, in the question generation apparatus 10, the output difference calculation unit 51 may generate new output difference information using the corpus in which the new user known word is reflected, thereby predicting a user known word again. Then, the ranking processor 53 may update the order of the words used for the question in real time. In this case, the output difference calculation unit 51 is an example of a unit configured to calculate the plural differences using another user known word recognized from an answer of a user to the question in place of the specific user known word, and the ranking processor 53 is an example of a unit configured to regenerate a question using the plural target words based on the plural differences.

### Processor

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Program

The process performed by the question generation apparatus 10 according to the present exemplary embodiment is prepared, for example, as a program such as application software.

That is, the program implementing the present exemplary embodiment is considered as a program that causes a computer to execute: calculating a difference between (i) a semantic representation of a specific user known word obtained from a first model that has learned semantic representations of words using a specific set of example sentences and (ii) a semantic representation of the specific user known word obtained from a second model that has learned semantic representations of words using a part of the specific set of example sentences excluding a target word; and outputting information on a possibility that the target word is a user known word based on the difference.

The program implementing the present exemplary embodiment may be provided by a communication unit, or may be provided in a form in which the program is stored in a recording medium such as a CD-ROM.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information output apparatus comprising:
a processor configured to:
calculate a difference between (i) a semantic representation of a specific user known word obtained from a first model that has learned semantic representations of words using a specific set of example sentences and (ii) a semantic representation of the specific user known word obtained from a second model that has learned semantic representations of words using a part of the specific set of example sentences excluding a target word; and
output information on a possibility that the target word is a user known word based on the difference.

2. The information output apparatus according to claim 1, wherein
the processor is configured to:
calculate a plurality of differences by calculating the difference for each of a plurality of the target words; and
output the plurality of target words arranged in order based on the differences for the respective target words, as information on the possibilities that the target words are the user known words.

3. The information output apparatus according to claim 2, wherein the order based on the differences is descending order of the difference.

4. The information output apparatus according to claim 1, wherein
the second model is a model obtained by causing an unlearned model to newly learn semantic representations of words using the part of the specific set of example sentences excluding the target word.

5. The information output apparatus according to claim 4, wherein
the part of the specific set of example sentences excluding the target word is a part of an element, which includes at least one of the specific user known word or the target word, of the specific set of example sentences excluding the target word.

6. The information output apparatus according to claim 1, wherein
the second model is a model obtained by causing a learned model to further learn semantic representations of words using the part of the specific set of example sentences excluding the target word.

7. The information output apparatus according to claim 6, wherein
the part of the specific set of example sentences excluding the target word is a part of an element, which includes the target word, of the specific set of example sentences excluding the target word.

8. A question generation apparatus comprising:
a processor configured to:
calculate a plurality of differences by calculating, for each of a plurality of target words, a difference between (i) a semantic representation of a specific user known word obtained from a first model that has learned semantic representations of words using a specific set of example sentences and (ii) a semantic representation of the specific user known word obtained from a second model that has learned semantic representations of words using a part of the specific set of example sentences excluding the target word; and
generate a question using the plurality of target words based on the plurality of differences.

9. The question generation apparatus according to claim 8, wherein
the processor is configured to:
calculate the plurality of differences using another user known word recognized from an answer of a user to the question in place of the specific user known word; and
regenerate a question using the plurality of target words based on the plurality of differences.

10. A non-transitory computer readable medium storing a program that causes a computer to execute an information output process, the information output process comprising:
calculating a difference between (i) a semantic representation of a specific user known word obtained from a first model that has learned semantic representations of words using a specific set of example sentences and (ii) a semantic representation of the specific user known word obtained from a second model that has learned semantic representations of words using a part of the specific set of example sentences excluding a target word; and
outputting information on a possibility that the target word is a user known word based on the difference.
